(19) United States
(12) Patent Application Publication
(10) Pub. No.: US 2022/0118628 A1
(43) Pub. Date: Apr. 21, 2022

(54) Technique for Controlling Wireless Command Transmission to a Robotic Device

(71) Applicant: Telefonaktiebolaget LM Ericsson (publ), Stockholm (SE)

(72) Inventors: Géza Szabó, Kecskemét (HU); Sándor Rácz, Cegléd (HU); Norbert Reider, Tényö (HU); José Araújo, Stockholm (SE)

(21) Appl. No.: 17/426,312

(22) PCT Filed: Feb. 15, 2019
(86) PCT No.: PCT/EP2019/053812

§ 371 Date: Jul. 28, 2021

(51) Int. Cl. B25J 13/00; G08C 17/02

(52) U.S. Cl. CPC B25J 13/006; G08C 17/02

(57) ABSTRACT

A controller for controlling wireless command transmission to a robotic device is presented, wherein the robotic device is capable of selectively performing a collaborative task with another entity and a non-collaborative task. The controller is configured to identify if a task to be performed by the robotic device is a collaborative or non-collaborative task, and to trigger a setting of at least one transmission parameter for a wireless command transmission to have the robotic device perform the task, wherein the setting is dependent on whether the task to be performed is a collaborative or a non-collaborative task.

### TECHNICAL FIELD

The present disclosure generally relates to industrial automation. In particular, a technique for controlling wireless command transmission to a robotic device is presented. The technique may be implemented in the form of a controller, a cloud-based robotic device control apparatus, a radio network system, a method, and a computer program product.

### BACKGROUND

In industrial automation, there are considerations to build robot cells from multiple robotic devices (such as collaborative robot arms) and to control these robot cells from a remote site. The remote control functionalities are, for example, deployed in a computing cloud, and control commands generated in the computing cloud are wirelessly transmitted to the robotic devices in the robot cells.

Existing communication protocols for industrial automation (e.g., EtherCAT or ProfiNet) have been developed for local robot cell control in which the controller is located in the robot cell and connected to the robotic devices via wire-based field buses. These protocols assume that the communication between the local controller and the robotic devices is reliable and has no substantial delay.

Field buses provide a comparatively deterministic transmission behaviour with low command transmission delay and are not impacted by the challenges and uncertainties of wireless command transmission, including packet loss, jitter, wireless spectrum availability, re-transmission delay, and proper resource allocation. As such, wireless command transmission negatively impacts the deterministic behaviour of robot cell control compared to wire-based solutions. To minimize this negative impact, one may think of using wireless transmission settings that guarantee a constantly high Quality of Service (QoS) for wireless command transmission. Evidently, such settings will tend to maximize wireless resource usage.

### SUMMARY

There is a need for a technique of controlling wireless command transmission to robotic devices that permits to cope with the uncertainties of wireless transmission channels while optimizing wireless resource usage.

According to a first aspect, a controller for controlling wireless command transmission to at least a first robotic device is presented, wherein the first robotic device is capable of selectively performing a collaborative task with another entity and a non-collaborative task. The controller is configured to identify if a task to be performed by the first robotic device is a collaborative or non-collaborative task, and to trigger a setting of at least one transmission parameter for a wireless command transmission to have the first robotic device perform the task, wherein the setting is dependent on whether the task to be performed is a collaborative or a non-collaborative task.

The first robotic device may be configured to serially perform a collaborative task and a non-collaborative task. In particular, the first robotic device may be configured to temporarily perform a collaborative task that is temporally arranged between a first non-collaborative task and a second non-collaborative task, or vice versa. During a collaborative task with the other entity, control of the first robotic device may temporarily be coupled with, or influenced by, the other entity.

The transmission parameter setting for a collaborative task may provide a higher QoS for wireless command transmission than the transmission parameter setting for a non-collaborative task. The QoS may be defined by one or more of transmission latency, re-transmission delay, packet loss, and jitter.

In certain variants, the transmission parameter setting for transmission of an individual command can temporarily reduce or increase QoS requirements for a wireless transmission channel dependent on the type of task underlying a previous (e.g., completed) wireless command transmission and the type of task underlying the upcoming wireless command transmission. The task types include or consist of collaborative and non-collaborative tasks. As such, wireless resource usage can be optimized in dependence on the type of task for which a command currently needs to be transmitted. In this manner, the technical insight is exploited that certain types of tasks permit the usage of more relaxed transmission parameter settings than other types of tasks.

The setting of the at least one transmission parameter may be defined by at least one of an associated transmission resource consumption level and an associated QoS level of a wireless transmission channel. The QoS level may, for example, pertain to QoS control at a service data flow level, at a QoS flow level, or at a packet data unit session level (see, e.g., section 4.3.3 of 3rd Generation Partnership Project (3GPP) Technical Specification (TS) 23.503 V15.1.0 (2018-03)). Additionally, or in the alternative, the different QoS settings may be realized by switching between different wireless transmission channels (that may provide differentiated data services). In regard to channel switching and differentiated data services, reference is made to section 5.7 of 3GPP TS 23.501 V15.2.0 (2018-06).

The transmission parameter setting for a collaborative task may be associated with a higher control update frequency than the transmission parameter setting for a non-collaborative task. Additionally, or in the alternative, the transmission parameter setting for a collaborative task may be associated with a lower control tolerance than the transmission parameter setting for a non-collaborative task.

The controller may be configured to determine a control tolerance setting for at least the first robotic device dependent on the identified task type. The control tolerance setting may pertain to a feedback-based control loop for at least the first robotic device. The controller may trigger application of the determined control tolerance setting for execution of the command. The control tolerance setting may influence an inverse kinematics-based control of the robotic device. Of course, the robotic device could alternatively be controlled using direct kinematics. In some variants, the command relates to a movement of the robotic device. The control tolerance setting may thus relate to a control tolerance of at least one of a movement goal path (i.e., a target path), a movement goal position (i.e., a target position) and a movement goal time (i.e., a target time when the movement position is to be reached).

The collaborative task may involve a physical interaction between the first robotic device and the other entity. The other entity may be a second robotic device. Alternatively, the other entity may be a human being (e.g., a worker in an industrial facility or a machine operator).

In the case of a collaborative task involving the first robotic device and the second robotic device, the controller may be configured to trigger, when the task to be performed by the first robotic device is identified to be a collaborative task, wireless command transmission towards both the first robotic device and the second robotic device with a transmission parameter setting for the collaborative task. Wireless command transmission towards both the first robotic device and the second robotic device may be performed via the same or via different radio resources (e.g., radio bearers, radio network slices, radio network systems such as radio access networks, and so on).

The controller may be configured to evaluate measurements from a robot control function so as to identify if the task to be performed by the first robotic device is a collaborative or a non-collaborative task. If, for example, the first robotic device is associated with a first robot control function and the second robotic device is associated with a second robot control function, similarities in measurements taken in regard of the first and the second robot control functions may be evaluated to identify that the task to be performed by the first robotic device is a collaborative task. In same variants, the first robot control function comprises a first control loop and the second robot control function comprises a second control loop, wherein the measurements are taken in regard to the first and the second control loops.

The controller may also be configured to compare the measurements with a model for at least one of a collaborative robotic device system and a non-collaborative robotic device system. The comparison may be made to identify if the task to be performed by the first robotic device is a collaborative or a non-collaborative task. The model may be a model of a robotic transfer function (e.g., a frequency domain model). Alternatively, the model may be a time domain model.

The measurements may pertain to differences of at least one of positions and orientations of the first and second robotic devices. As an example, the measurements may pertain to differences of a quaternation of tool center points associated with the first and second robotic devices.

The controller may be configured to inspect data packets so as to identify if the task to be performed by the first robotic device is a collaborative or a non-collaborative task. The data packets may include commands to have at least the first robotic device perform the task. The data packets may be intended for wireless command transmission to at least the first robotic device.

The controller may be configured to send a control signal to a radio network system in charge of wireless command transmission. The control signal may be configured to trigger the transmission parameter setting for the wireless command transmission. In a first variant, the control signal is sent in-band with a command pertaining to the task to be performed by the first robotic device. The control signal may in such a case be transmitted using marking of a data packet transporting a command. In a second variant, the control signal is sent out-of band and separately from a command pertaining to the task to be performed by the first robotic device. In an out-of band solution, translating capabilities may be provided on the side of the network access domain to translate the control signal into a request (e.g., a call) that can properly be processed by a wireless transmission protocol used for command transmission to the one or more robotic devices.

Also provided is a radio network system for wireless command transmission to one or more robotic devices. The radio network system comprises an interface to receive robotic device commands from a cloud-based robotic device control function for wireless transmission towards one or more robotic devices, and one of the controller as presented herein and capabilities to receive a control signal from the controller as presented herein, wherein the control signal is configured to trigger a transmission parameter setting for the wireless command transmission.

The radio network system may be configured to identify one or more wireless transceiver entities co-located and associated with the one or more robotic devices, wherein the transmission parameter setting pertains to a wireless connection between the radio network system and each wireless transceiver entity. The identification may be based on one of a virtual extension local area network (VXLAN) tunnel to a robotic device, a robotic device identifier and an Ethernet identifier of a robotic device.

Also presented is a cloud-based robotic device control apparatus comprising a first interface configured to send robotic device commands to a radio network system for wireless transmission towards one or more robotic devices, and further comprising the controller presented herein.

The cloud-based robotic device control apparatus may comprise a second interface different from the first interface and configured to send control signals to the radio network system. The control signals may be configured to trigger a transmission parameter setting for a wireless command transmission. The control signal may be sent out-of band via the second interface in relation to the robotic device commands that are sent via the first interface.

Moreover, a method of controlling wireless command transmission to at least a first robotic device is presented, wherein the first robotic device is capable of selectively performing a collaborative task with another entity and a non-collaborative task. The method comprises identifying if a task to be performed by the first robotic device is a collaborative or non-collaborative task, and triggering a setting of at least one transmission parameter for a wireless command transmission to have the first robotic device perform the task, wherein the setting is dependent on whether the task to be performed is a collaborative or a non-collaborative task.

The method may be performed by a device as presented herein, a radio network system as presented herein, or a cloud-based robotic device control apparatus as presented herein.

Also provided is a computer program product comprising program code portions for performing the steps of any of the method aspects presented herein when executed by one or more processors. The computer program product may be stored on a computer-readable recording medium. The computer program product may also be provided for download via a network connection.

### BRIEF DESCRIPTION OF THE DRAWINGS

Further aspects, details and advantages of the present disclosure will become apparent from the detailed description of exemplary embodiments below and from the drawings, wherein:

FIGS. 1A & B illustrate network system embodiments of the present disclosure;

FIGS. 2A & B illustrate robot cell controller embodiments of the present disclosure;

FIG. 3 illustrates a method embodiment of the present disclosure;

FIGS. 4 & 5 illustrate further network system embodiments of the present disclosure with associated control aspects; and

FIGS. 6A & B illustrate network systems performing a non-collaborative task and a collaborative task, respectively.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, the following description focuses on specific radio access network types such as 5^{th} Generation (5G) networks, the present disclosure can also be implemented in connection with other radio access network types. Moreover, while certain aspects in the following description will exemplarily be described in connection with cellular networks, particularly as standardized by 3GPP, the present disclosure is not restricted to any specific wireless access type.

Those skilled in the art will further appreciate that the steps, services and functions explained herein may be implemented using individual hardware circuitry, using software functioning in conjunction with a programmed microprocessor or general purpose computer, using one or more Application Specific Integrated Circuits (ASICs) and/or using one or more Digital Signal Processors (DSPs). It will also be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the following description of exemplary embodiments, the same reference numerals denote the same or similar components.

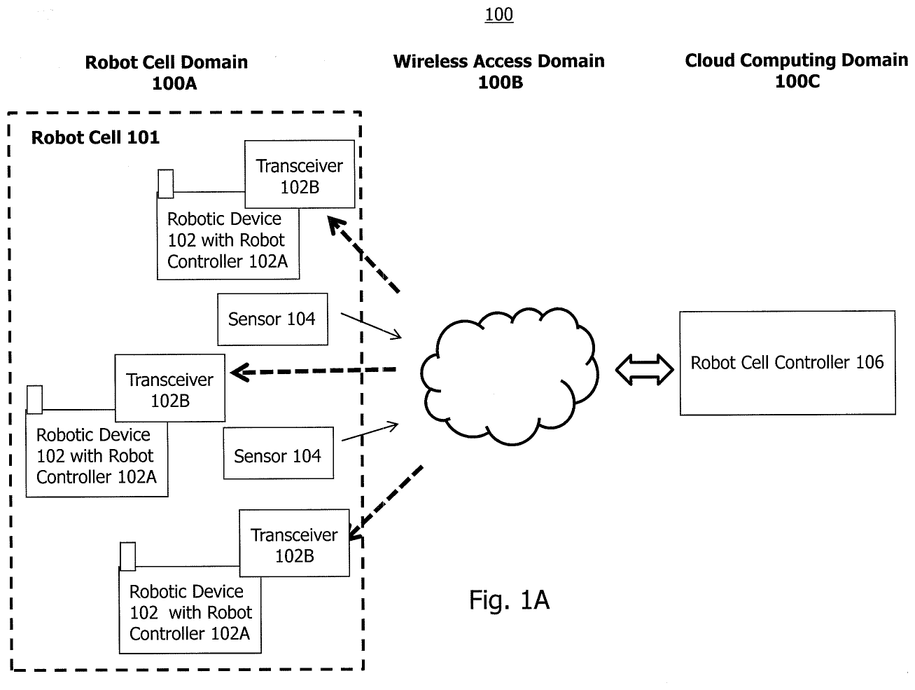

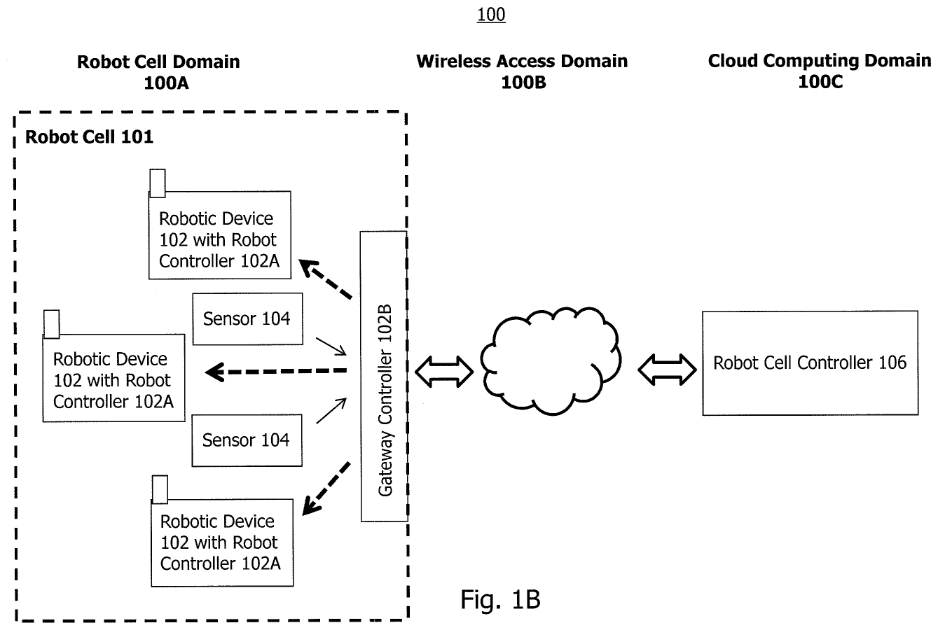

FIG. 1A illustrates an embodiment of a network system 100 for computing cloud-based robot cell control. As shown in FIG. 1A, the network system 100 comprises a robot cell domain 100A, a wireless access domain 100B as well as a cloud computing domain 100C.

The robot cell domain 100A comprises at least one robot cell 101 with multiple robotic devices 102 each having at least one dedicated local robot controller 102A in association therewith. Each of the robotic devices 102 can comprise one or multiple actuators (not illustrated in FIG. 1A). As an example, an exemplary robotic device 102 in the form of a robot arm may comprise multiple robot arm joints with associated actuators, so that the robot arm is movable in various degrees of freedom. A dedicated local robot controller 102A may be provided for each individual actuator.

Each robotic device is 102 is associated with a dedicated wireless transceiver entity 102B configured to wirelessly communicate with the wireless access domain 100B. In some variants, the wireless transceiver entities 102B may be realized as so-called user equipments (UEs).

Each robotic device 102 may be configured to serially perform a collaborative task and a non-collaborative task. In other words, each robotic device 102 may be configured to perform a collaborative task that is temporally arranged between a first non-collaborative task and a second non-collaborative task, or vice versa. During a collaborative task, two of the robotic devices 102 may temporarily be coupled to each other from a control perspective (e.g., a task performed by one of the two robotic devices 102 may have an effect on a control strategy for the other robotic device 102).

The robot cell domain 100A further comprises multiple sensors 104 such as cameras, position sensors, orientation sensors, angle sensors, and so on. The sensors 104 generate sensor data indicative of a state of the robot cell 101 (i.e., cell state data). The sensors 104 can be freely distributed in the robot cell 101. One or more of the sensors 104 can also be integrated into one or more of the robotic devices 102. As an example, each individual actuator of a multi-actuator robotic device 102 may be provided with a dedicated sensor 104. Each of the sensors 104 may re-use an associated transceiver entity 102B or may be provided with a dedicated transceiver entity (not shown) for wireless sensor data transmission to the wireless access domain 100B.

The wireless access domain 100B may be a cellular or non-cellular network, such as a cellular network specified by 3GPP. In some implementations, the wireless access domain 100B may be compliant with the 3GPP standards according to Release R15, such as one or both of TS 23.503 V15.1.0 (2018-3) or later and 3GPP TS 23.501 V15.2.0 (2018-06) or later. The wireless access domain 100B may comprise a base station or a wireless access point (not shown) that enables a wireless communication between components of the robot cell 101 on the one hand and the cloud computing domain 100C on the other hand via the wireless access domain 100B.

As illustrated in FIG. 1A, the robotic devices 102 with their associated robot controllers 102A are configured to receive control commands generated in the cloud computing domain 100C via wireless transmissions from the wireless access domain 100B to the associated wireless transceiver entity 102B. Moreover, the sensor data as acquired by the sensors 104 are wirelessly communicated via the wireless access domain 100B to the cloud computing domain 100C to inform same about the state of the robot cell 101. Processing of the sensor data (e.g., in the context of inverse kinematics) at least partially takes place in the cloud computing domain 100C. The processed sensor data may then again form the basis for control command generation in the computing cloud domain 100C. In this way, a control loop may be established. In this way, control command generation in the cloud computing domain 100C is based on actions, or tasks, defined in a plan for one or more of the robotic devices 102.

The cloud computing domain 100C comprises a robot cell controller 106 composed of could computing resources. The robot cell controller 106 is configured to receive the sensor data (i.e., cell state data) from the sensors 104 via the wireless access domain 100B. The robot cell controller 106 is further configured to generate control commands for the robotic devices 102, optionally on the basis of the sensor data, and to forward the control commands via the wireless access domain 100B to the robot controllers 102A of the robotic devices 102. The robot controllers 102A are configured to wirelessly receive the control commands and to control one or more individual actuators of the respective robotic device 102 based thereon.

FIG. 1B illustrates an embodiment of a further network system 100 similar to the one shown in FIG. 1A. In the network system 100 of FIG. 1B, the local robot controllers 102A of FIG. 1A are no longer capable of wirelessly receiving the control commands directly from the wireless access domain 100B. Rather a central gateway controller 102B comprising a dedicated wireless transceiver entity, such as a UE, is provided and configured to wirelessly receive the control commands from the wireless access domain 100B and to forward the control commends wire-based (e.g., via a field bus) or wirelessly to the local robot controllers 102A. Using a central gateway controller 102B, a synchronous control of interworking robotic devices 102 becomes easier. The gateway controller 102B also collects the sensor data from the sensors 104 and wirelessly transmits same to the computing cloud domain 100C. The connections between the gateway controller 102B and the sensors 104 may be wire-based (e.g., based on field buses) or wireless.

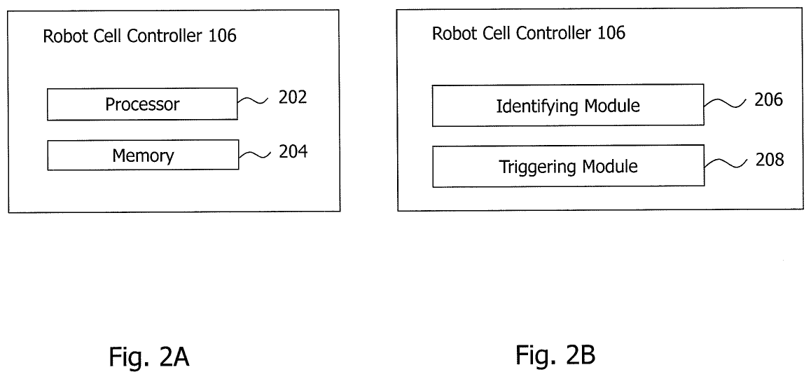

FIGS. 2A and 2B illustrate two embodiments of the computing cloud-based robot cell controller 106 of FIGS. 1A and 1B. In the embodiment illustrated in FIG. 2A, the cloud-based robot cell controller 106 comprises a processor 202 and a memory 204 coupled to the processor 202. Optionally, the controller 106 further comprises one or more interfaces for communication with other components of the network system 100 of FIGS. 1A and 1B, in particular with the wireless access domain 100B. The memory 204 stores a computer program product (i.e., software code) that controls the operation of the processor 202.

The processor 202 is configured to identify if a task to be performed by one or more of the robotic devices 102 illustrated in FIGS. 1A and 1B is a collaborative or a non-collaborative task. A collaborative task may involve two or more of the robotic devices 102 or one of the robotic devices 102 and another entity, such as a human worker or operator in the robot cell 101. The processor 202 is further configured to trigger a setting of at least one transmission parameter for a wireless command transmission to have the first robotic device perform the task, wherein the setting is dependent on whether the task to be performed is a collaborative or a non-collaborative task.

FIG. 2B shows an embodiment in which the computing cloud-based robot cell controller 106 is implemented in a modular configuration. As shown in FIG. 2B, the controller 106 comprises an identifying module 206 configured to identify if a task to be performed by one or more of the robotic devices 102 illustrated in FIGS. 1A and 1B is a collaborative or a non-collaborative task. The controller 106 further comprises a triggering module 208 configured to trigger a setting of at least one transmission parameter for a wireless command transmission to have the first robotic device perform the task, wherein the setting is dependent on whether the task to be performed is a collaborative or a non-collaborative task.

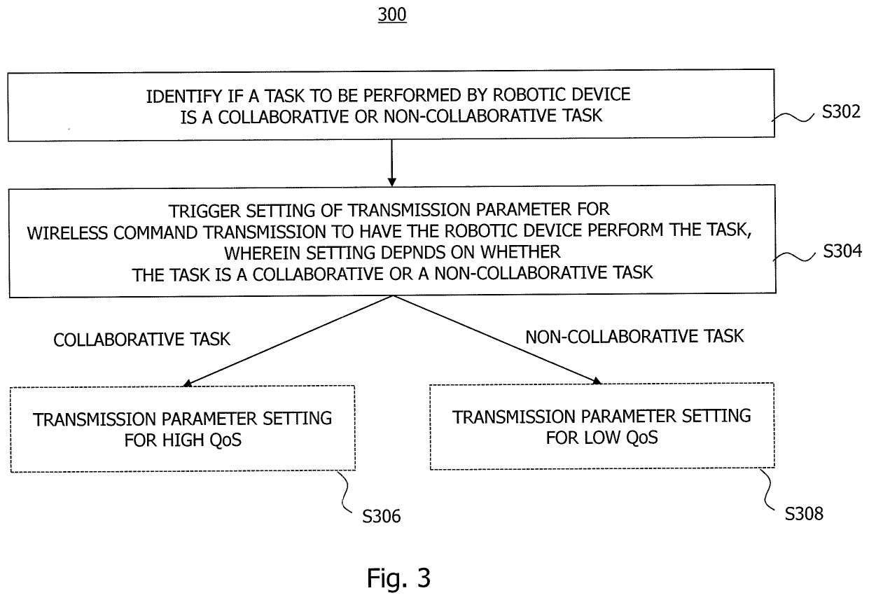

FIG. 3 illustrates in a flow diagram 300 a method embodiment of controlling wireless command transmission to a robotic device 102. The method embodiment may be performed by any of the controllers 106 of FIG. 2A or 2B, or by a controller having a different configuration. As an example, the controller could also be located in the wireless access domain 100B.

In step S302, the controller 106 identifies if a task to be performed by one or more of the robotic devices 102 illustrated in FIGS. 1A and 1B is a collaborative or a non-collaborative task. Various variants for performing such identification will be described in greater detail below. A collaborative task may for example involve a physical interaction between two robotic devices 102 in which one robotic device 102 hands over a work piece to another robotic device 102.

Alternatively, or in addition, the controller 106 may evaluate measurements from a robot control function (e.g., from a control loop) so as to identify if the task to be performed by a particular robotic device is a collaborative or a non-collaborative task. The measurements may be taken in the robot cell domain 100A, the wireless access domain 100B or the cloud computing domain 100C (or in two or all of these domains 100A, 100B, 100C, such as in both the robot cell domain 100A and the cloud computing domain 100C).

As a further example, data packets may be inspected so as to identify if the task to be performed by a particular robotic device 102 is a collaborative or a non-collaborative task. Such data packets include commands to have the robotic device 102 perform the task and are intended for wireless command transmission to the robotic device 102. The inspection may be performed in at least one of the robot cell domain 100A and the wireless access domain 100B. In one variant, the inspection is based on a deep packet inspection (DPI) technique and performed in the wireless access domain 100B.

In a further step S304, a setting of at least one transmission parameter for a wireless command transmission is triggered to have the particular robotic device 102 perform the task. The robotic device 102 may comprise multiple actuators that, for example, define individual degrees of freedom. As understood herein, a control command may pertain to the robotic device 102 as a whole (and may thus comprise multiple sub-commands for the individual actuators), or it may pertain to an individual actuator of a multi-actuator robotic device 102.

The transmission parameter setting triggered in step S304 is dependent on whether the task to be performed is a collaborative or a non-collaborative task. In an exemplary QoS-based transmission parameter setting scenario, the transmission parameter setting for a collaborative task provides a higher QoS for wireless command transmission than the transmission parameter setting for a non-collaborative task. This is illustrated in FIG. 3 by two optional steps S306 (collaborative task/high QoS) and S308 (non-collaborative task/low QoS). QoS may be defined by one or more of transmission latency, re-transmission delay, packet loss, and jitter. Therefore, as an example, the transmission parameter setting for a non-collaborative task will allow for higher jitter than the transmission parameter setting for a collaborative task, but will typically consume less wireless transmission resources.

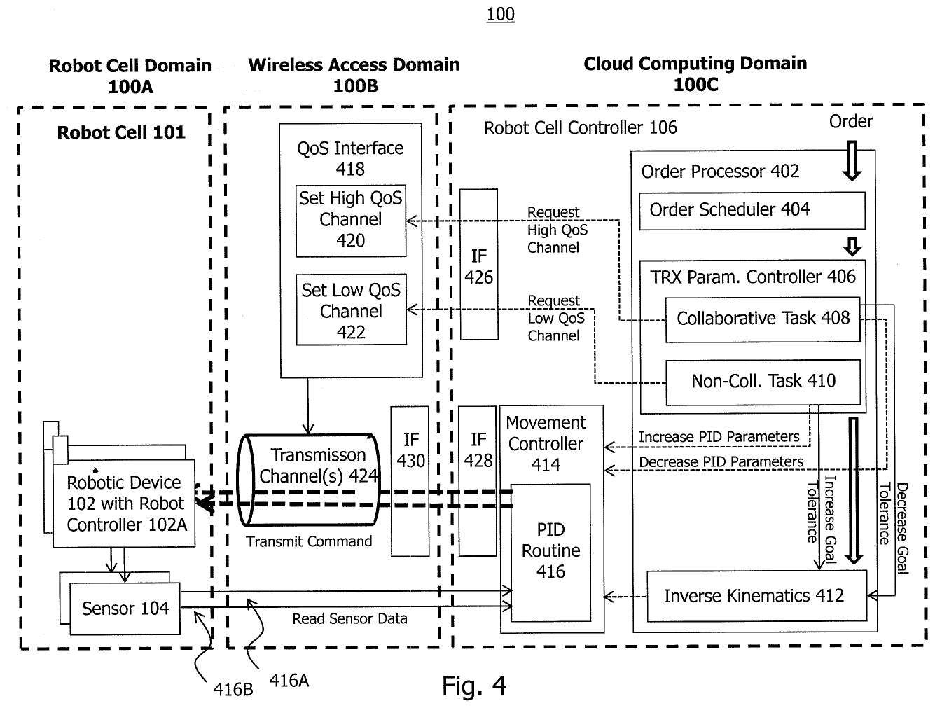

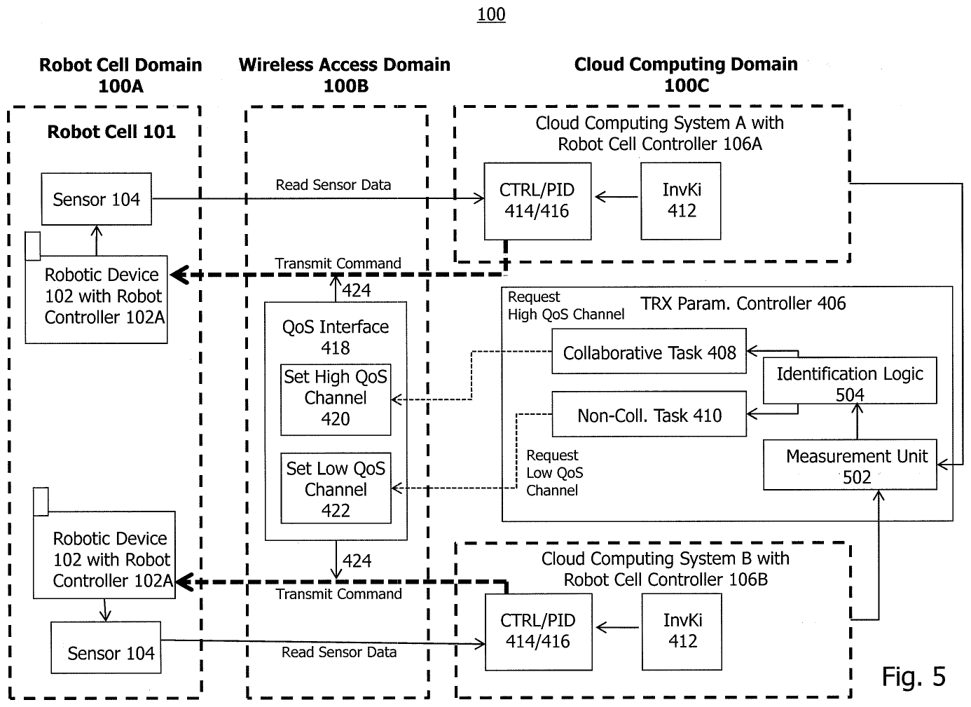

In the following, a further embodiment of a network system 100 will be described with reference to FIG. 4. The same reference numerals as in FIGS. 1A and 1B will denote the same or similar components.

As shown in FIG. 4, the robot cell controller 106 in the cloud computing domain 100C comprises an order processor 402 configured to receive orders to be implemented by one or more robotic devices 102 in the robot cell 101. The orders may comprise a series of one or more collaborative and non-collaborative tasks to be performed by one or more robotic devices 102 in the robot cell domain 100A. Based on the one or more tasks defined in a specific order, the robot cell controller 106 generates one or more associated control commands for a particular robotic device 102 or a set of robotic devices 102. As such, the control commands will typically be different from the tasks as defined in the orders, but there will exist a correspondence between tasks on the one hand and control commands on the other hand.

The order processor 402 comprises an order scheduler 404 configured to coordinate scheduling of the orders (and of the tasks defined therein) for transmission towards the robot cell domain 100A. Moreover, the order processor 402 comprises a transmission parameter controller 406 configured to control wireless command transmission by triggering task type-dependent transmission parameter settings in the wireless access domain 100B. In the present, exemplary embodiment, it will be assumed that each task contained in the orders received by the transmission controller 406 can be categorized into at least a collaborative task 408 and a non-collaborative task 410. A collaborative task 408 may be regarded as a task requiring a higher Quality of Control (QoC) in the robot cell domain 100A than a non-collaborative task 410.

It will be appreciated that in addition to the task types “collaborative” and “non-collaborative”, one or more further task types may be defined. It will further be appreciated that the transmission parameter controller 406 could also be located outside the order processor 402 but still within the cloud computing domain 100C.

Moreover, the transmission parameter controller 406 could at least partially be located in the wireless access domain 100E.

The order processor 402 further comprises an inverse kinematics component 412. The inverse kinematics component 412 is in charge of performing an inverse kinematics-based control of the one or more robotic devices 102 in the robot cell 101. This control may at least partially be based on sensor data gathered by one or more of the sensors 104 that monitor movements and states of the one or more robotic devices 102 in the robot cell 101.

The robot cell controller 106 also comprises a movement controller 414 configured to generate commands corresponding to the tasks as received from the order processor 402, and to send the generated commands via the wireless access domain 100B towards the robot cell 101. For instance, if one of the robotic devices 102 is a robot arm, one task could be a robot arm movement along a trajectory from A to B, which movement is translated by the movement controller 414 into one or more control commands for locally controlling one or more robot arm joint actuators to execute the trajectory from A to B.

The movement controller 414 is configured to include a proportional/integral/differential (PID) routine 416 for controlling execution of the commands. Thus, the movement controller 414 is configured to control the one or more robotic devices 102 in accordance with a PID-based control strategy. In this regard, FIG. 4 illustrates two feedback loops 416 A, B each including the movement controller 414, an individual robotic device 102 and one or more sensors 104 returning sensor data pertaining to the robotic device 102 to be controlled is established.

The wireless access domain 100B comprises a QoS interface 418 that is configured to enforce the transmission parameter setting triggered (e.g., requested) by the robot cell controller 106. The QoS interface 118 may be implemented in a base station serving the robot cell 101 with the one or more robotic devices 102 and the one or more sensors 104.

As illustrated in FIG. 4, the QoS interface 418 is in particular configured to selectively implement one of a first transmission parameter setting associated with a high QoS channel (function 420) and a second transmission parameter setting associated with a low QoS channel (function 422). In this manner, a suitable transmission channel 424 for triggering either a collaborative task 408 in the robot cell 101 (via the high QoS channel setting function 420) or a non-collaborative task (via the low QoS channel setting function 422) can be selected.

If the transmission controller 406 determines that a command that is about to be dispatched to the robotic device 102 pertains to a collaborative task 408, it will transmit, via a control interface 426, a first type of control signal to request a high QoS channel 424 from the QoS interface 418. In a similar manner, when the transmission controller 406 determines that the command about to be dispatched is associated with a non-collaborative task 410, it will transmit, via the control interface 426, a second type of control signal to request the QoS interface 418 that the associated command is transmitted via a low QoS channel 424. The control signal will thus in each case trigger a suitable transmission parameter setting represented by either the high or low QoS channel 424.

In the scenario illustrated in FIG. 4, the control signal for requesting either a high QoS or low QoS channel 424 is sent out-of band and, thus, separately from the command. The robot cell controller 106 thus comprises, in addition to the control interface 426 for control signal transmission, a separate command interface 428 for command transmission to the wireless access domain 100B. On the side of the wireless access domain 1006, there exists the corresponding interface 418 for reception and processing of the control signals and a further interface 430 for command reception. Alternatively, the control signals and the commands may be sent in-band from the robot cell controller 106 to the wireless access domain 100B via a single interface at each side.

Using a low QoS channel 424 for command transmission may introduce a control delay (i.e., latency) in regard to the robotic device 102 to be controlled. This control delay, in turn, may be lead to an error condition in the movement controller 414. In the following, various variants for avoiding such unwanted error conditions in case of a control delay intentionally introduced by a particular transmission parameter setting will be discussed.

According to one variant, a control tolerance setting for the robotic device 102 is set dependent on a QoS level associated with a specific task or the corresponding command. To this end, as shown in FIG. 4, a goal tolerance setting may be increased in regard to the inverse kinematics component 412 in case of a non-collaborative task 410. Additionally, or as an alternative, the goal tolerance setting may be decreased in case of a collaborative task 408. The goal tolerance setting may generally relate to one or more of a movement goal path, a movement goal position and a movement goal time associated with execution of a specific command by the robotic device 102. A specific control tolerance setting triggered by the transmission controller 406 in regard to the inverse kinematics module 412 may lead to an associated control of the movement controller 414 by the inverse kinematics component 412.

In addition, or as an alternative, to the task type-specific setting of the control tolerance, in a further variant one or more PID parameters are adjusted dependent on the task type (collaborative/non-collaborative) associated with a specific task or the corresponding command. As also illustrated in FIG. 4, the transmission controller 406 is configured to increase one or more PID parameters applied by the movement controller 414 in case of a non-collaborative task 410. In a similar manner, the transmission controller 406 is configured to decrease one or more PID parameters in case of a collaborative task 408. As such, a less aggressive PID parameter setting may be used for the implementation of a collaborative task 408 compared to the implementation of a non-collaborative task 410. Increasing, for example, the P parameter decreases the convergence time of the control, resulting in a faster execution of a movement path but with a higher overshooting and, thus, a lower accuracy. In some variants, the movement controller 414 may implement a P-based control only, meaning that the I and D parameters are not affected.

As has become apparent from the above, in one implementation the robot cell controller 106 is configured to control command execution by one or more of the robotic devices 102 as follows. Initially, the order processor 402 obtains one or more tasks (via an order) and determines the task type associated with each obtained task (see reference numerals 408 and 410 in FIG. 4). The order processor 402 then triggers a setting of at least one control parameter (e.g., the P parameter of a PID loop 416 and/or a goal tolerance parameter associated therewith) of the movement controller 414 for execution of a command pertaining to the task. This setting is dependent on the task type (and an optional QoC level associated therewith) determined by the order processor 402. The corresponding control parameter will control one of the PID loops 416 A, B that include a wireless transmission of the command to the associated robotic device 102 and of a feedback parameter detected by the associated sensor 104 back to the movement controller 414. If more than two task types (and, optionally, associated QoC levels) are defined, more than two associated PID parameter settings and/or control tolerance settings may be defined as well.

In the following, a further embodiment of a network system 100 will be described with reference to FIG. 5. The embodiment of FIG. 5 is based on the embodiment of FIG. 4, so that only the differences will be explained in greater detail. The same reference numerals as in FIG. 4 will denote the same or similar components.

Importantly, two (or more) separate cloud computing systems A and B are provided in the cloud computing domain 100C to control two (or more) robotic devices 102 in the robot cell 101. As such, different robotic devices 102 may be controlled via different cloud computing systems A, B. Each cloud computing system A and B implements a separate robot cell controller 106A and 106B, respectively, with separate movement controllers 414/PID routines 416 und separate inverse kinematics components 412. Also, each robot cell controller 106A, 106B will have a dedicated order processor (not shown).

In the scenario of FIG. 5, the transmission parameter controller 406 may be implemented in any of the cloud computing systems A and B but outside the associated order processor, or in a third cloud computing system (not shown). Moreover, the transmission parameter controller 406 could also be located outside the cloud computing domain 100C and, for example, in the wireless access domain 100B.

As shown in FIG. 5, the transmission parameter controller 406 comprises a measurement unit 502 and identification logic 504. The measurement unit 502 is configured to obtain measurements, for example from robot control functions in the cloud computing systems A and B, and the identification logic 504 is configured to process the measurements so as to identify, based on the measurements, if a specific task that is to be performed by a specific robotic device 102 is a collaborative or a non-collaborative task. The robot control functions from which measurements are taken may be the robot cell controllers 106A, 106B in general and, in particular, one or more of the movement controllers 414/PID routines 416 und inverse kinematics components 412 thereof. Additionally, or in the alternative, the measurements obtained by the measurement unit 502 could be taken by the sensors 104 in the robot cell domain 100A. These sensors 104 may or may not be part of the control loops 416A, B.

The identification logic 502 may compare the measurements with one or more models (e.g., of a robotic transfer function) to determine—based on similarities or deviations—that a specific task that is to be performed by a specific robotic device 102 is a collaborative or a non-collaborative task. The identification logic 502 need not necessarily rely on measurements. Rather, the identification logic 502 may also receive control signaling from another entity (e.g., as defined in an order submitted to the order processor 402) to identify whether to request a high QoS channel 420 or a low QoS channel 422.

It should further be noted that one or both of the measurement unit 502 and identification logic 504 as described above with reference to FIG. 5 could also form part of the transmission parameter controller 406 illustrated in FIG. 4. Moreover, the same interfaces as discussed above with reference to FIG. 4 may be implemented in the network system embodiment of FIG. 5.

When the transmission parameter controller 406 of FIG. 5 is located in the radio access domain 100B, the measurement unit 502 may be configured to inspect data packets (e.g., using DPI) that are to be wirelessly transmitted to the robot cell domain 100A and report the measured inspection results to the identification logic 504. The identification logic 504 is then configured to process the measured inspection results so as to identify if a specific task that is to be performed by a specific robotic device 102 is a collaborative or a non-collaborative task.

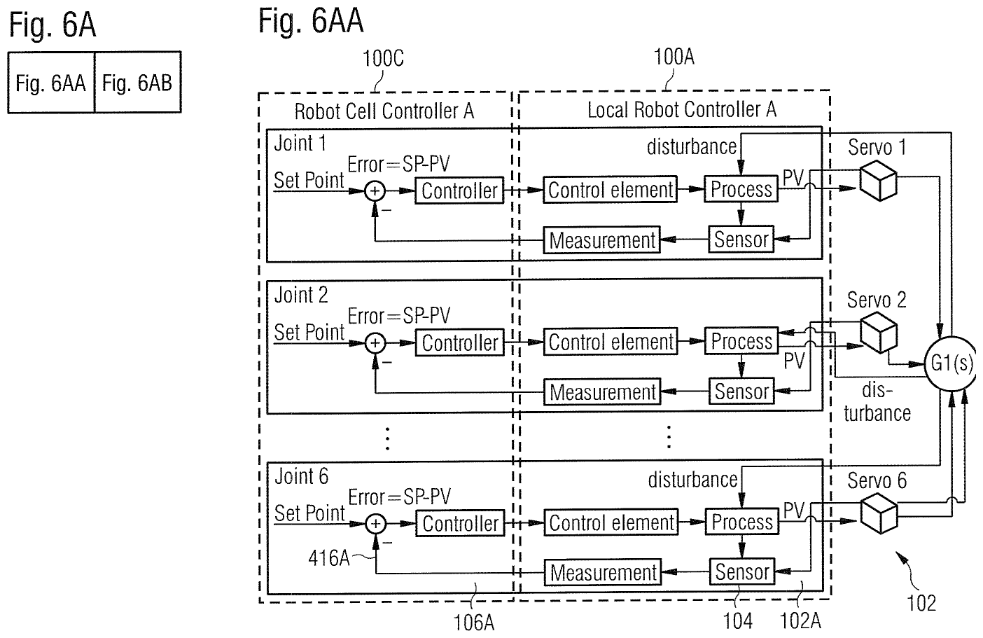

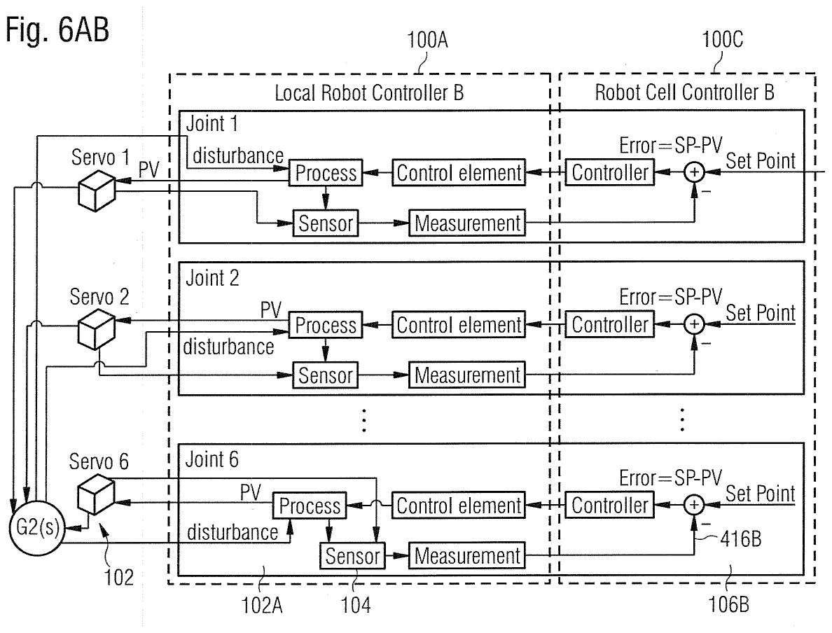

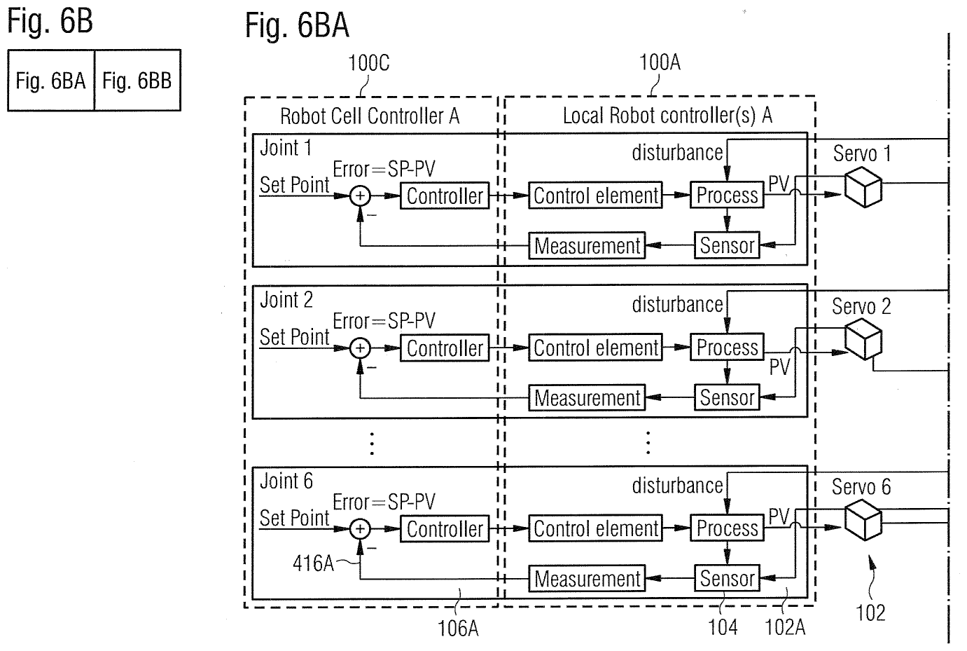

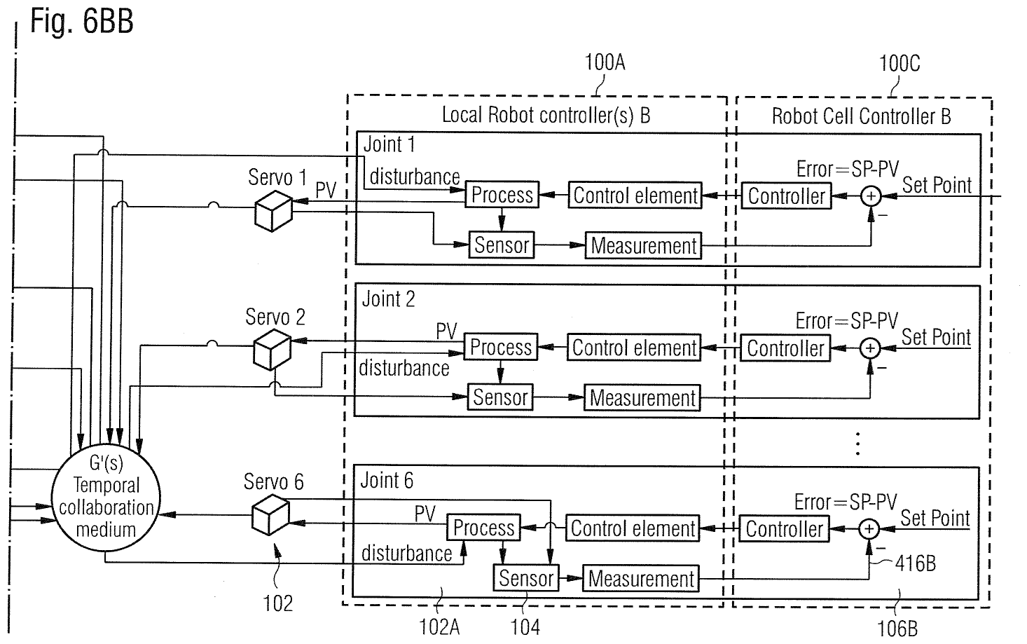

In the following, exemplary details about collaborative and non-collaborative tasks will be described with reference to the network system embodiments illustrated in FIGS. 6A and 6B. Again, the same reference numerals will denote the same or similar components as in FIGS. 1A to 5. The network system embodiments of FIGS. 6A and 6B may have the configuration illustrated in one of FIGS. 4 and 5, or another configuration.

Each of FIGS. 6A and 6B shows two robotic devices 102 exemplarily controlled via separate robot cell controllers 106A and 106B (see FIG. 5). Each robotic device 102 takes the form of a robot arm comprising six individual actuators (Servo 1 to Servo 6) for actuating an associated robot arm joint. For each robot arm joint actuator, a dedicated local robot controller 102A is provided on the side of the robot cell domain 100A. Moreover, for each robot arm joint actuator a dedicated PID-based control loop 416A, B is provided. The control loops involving robot cell controller 106A are denoted by reference numeral 416A, and the control loops involving robot cell controller 106B are denoted by reference numeral 416B.

Each control loop 416A, B comprises an adder and a controller on the side of the respective cloud-based robot cell controller 106A, 106B and a control element, a process and a sensor 104 providing measurements on the side of the robot cell domain 100A. Each adder is configured to compare for a particular robot arm joint actuator a command-based set point with an associated measurement, and to generate a new commend so as to minimize the deviation, as is known in the art of PID control. The loop control frequency may range between 50 Hz and 500 Hz (e.g., approximately 100 Hz). It should be noted that there may be an inner analog control loop (not shown) per robot joint actuator that operates at a much higher control frequency of 1 kHz or more (e.g., at approximately 2 kHz).

FIG. 6A illustrates the case in which the two robotic devices 102 work on the same work product but without physical interaction between the two robotic devices 102. As such, it is sufficient to ensure that the trajectories of the two robotic devices 102 do not interfere so as to avoid physical damage, but otherwise the control loops 416A of one of the two robotic devices 102 are not influenced by the control loops 416B of the other robotic device 102. This means that the two robotic devices 102 have dedicated transfer functions G1(s) and G2(s), respectively, which are not or only loosely coupled. Such a non-existing or loose coupling is an indicator for the fact that the two robotic devices 102 do not perform a collaborative task. In other words, FIG. 6A illustrates the control scenario of a non-collaborative task.

FIG. 6B, on the other hand, illustrates the case in which the two robotic devices 102 work on the same work product and with temporary physical interaction between the two robotic devices 102. As an example, one of the two robotic devices 102 may pass a work piece to the other robotic device 102, or each positions a work piece relative to the work product and the other work piece. As such, the control loops of the two robotic devices 102 will temporarily be tightly coupled. This means that the interaction between the two robotic devices 102 can be described by a common transfer function G′(s). Such a coupling and the resulting common transfer function G′(s) are indicators for the fact that the two robotic devices 102 do perform a collaborative task.

In the following, various embodiments for automatically detecting that two or more robotic devices 102 are to perform or are performing a collaborative task will be described in more detail. These embodiments may be implemented in any of the network system configurations discussed above.

Collaboration with the Wireless Access Network Domain 100B

The cloud-based robot cell controller 106 can be aware of the controlled robotic elements. It can, for example, be assumed that during an assembly process the robot arms collaborating with each other are controlled within the same 5G network slice. The transmission parameter controller 406 may detect or may be made aware of temporary collaborations between the robot arms, and it thus can automatically request a high QoS channel for command transmission during a collaboration period. In the following, two variants will be discussed in more detail.

1. QoS Request API

The realization of the QoS control signaling has numerous options. One possible option in a 5G-based access network domain 100B is to use suitable 5G interfaces for the QoS interface 418 in FIG. 4. Switching between various channels 424 providing the necessary QoS/QoC requirements can be based on the channel switching and differentiated data services techniques as defined in section 5.7 of 3GPP TS 23.501 V15.2.0 (2018-06).

Such an approach enables differentiated data services to support diverse application requirements while using radio resources efficiently. It is designed to support different access networks, where QoS without extra signaling (and extra interfaces) may be desirable. To realize such in-band signaling, in same implementations standardized packet marking may inform the QoS interface 418 via the command interface 428 what QoS to provide (without any out-of band QoS signaling, so that the interface 426 in FIG. 4 could be omitted or could temporarily not be used).

Existing application programming interfaces (API) for QoS signaling (QoS interface 418 in FIG. 4), such as those defined in the 5G specifications, might not support on-the-fly QoS signaling in terms of the granularity and time-scale of a robot control. Thus, predetermined collaborative phases can be signaled in advance of a movement start phase to the access network domain 1006, in particular in case the movement start phase relates to a collaborative task. It is, on the other hand, less critical from the perspective of robotic device control if signaling for a non-collaborative is temporarily (still) performed using a transmission parameter setting for a collaborative task

2. Identification of the Robots

The cloud based robot cell controller 106 is aware of temporary collaborative tasks to be performed by the robotic devices 102. Associated collaboration signaling can be forwarded to the network access domain 100B (e.g., the relevant 5G slice) via a dedicated API, see interface 426 in FIG. 4. Using this dedicated interface 426, switching between channels providing 424 providing high QoS and low QoS can be signaled, as explained above.

In such an implementation, the QoS interface 418 can be configured to translate the control signaling received from the cloud computing domain 100C into standardized signaling from the perspective of the wireless communication protocol (such as into 5G QoS setting API calls). In this manner, the wireless communication protocol can “understand” and apply the requested transmission parameter settings for the transmission channels 424.

As said, the dedicated API may be realized by the control interface 426 as illustrated in FIG. 4 to enable out-of band signaling. However, then the network access domain 100B (e.g., the relevant 5G slice) may need to identify the proper wireless transceiver entity 102B in the robot cell domain 100A that serves a specific one of the collaborative robotic devices 102. This applies in particular to the network system configuration illustrated in FIG. 1A in which each robotic device 102 has a dedicated wireless transceiver entity 102B.

There are several methods that can handle this issue. These methods may require manual configuration.

A first solution can be based on VXLAN tunneling. There are distinct VXLAN tunnels created between the cloud based robot cell controller 106 and each controlled robotic device 102. In this way, the local transceiver entities 102B need to do a regular flow based QoS service handling like in the bearer concept. VXLAN tunneling is a solution to tunnel traffic between two endpoints into a user datagram protocol/internet protocol (UDP/IP) tunnel. This approach permits to identify (based on the 5-tuple, i.e., source IP/port, destination IP/port and transmission protocol) which data flow needs a given QoS channel 424 to be set up. In this manner, different QoS transmission parameter settings can be applied for different flows (as is done today in the 3GPP bearer concept). That is, different QoS services can be defined already today for different UDP/IP flows. Proper set-up of the VXLAN tunnels may involve manual configuration.

Another solution assumes that the wireless access domain 100B (e.g., a particular 5G slice) provides Ethernet forwarding. In this case, a robotic device ID could be applied, which is known by the cloud based robot cell controller 106 and also provided to the wireless access domain 100B. Then, the wireless access domain 100B can perform the pairing of transmission channel configuration and command transmission.

A third solution is that the robotic device 102 has a built-in transceiver entity 102B and its Ethernet address could be an identifier usable by the wireless access domain 100B for temporarily selecting a high QoS channel 420 for an individual robotic device 102 during a collaborative phase. This solution needs to be refined in case multiple robotic devices 102 are handled by a single transceiver entity, since the robotic devices 102 are hidden for the wireless access network domain 100B, and only one PDU session per transceiver entity 102B is allowed.

In the above scenarios, transitions between the low/high QoS phases should be timed precisely by the wireless access domain 100B.

Statistical Identification of Collaborative Tasks

The characteristics of the robotic transfer functions, and the behavior of the robot-describing models, of independent robot control functions (e.g., independent control loops 416A and 416B as illustrated in FIG. 6A) are similar to each other in case of controlling the same robotic device hardware. In case of different robotic device hardware, the transfer functions can be clearly distinguishable.

In case of a transition to a collaborative task and a resulting temporary coupling, the disturbance functions of the two control loops 416A, 416B (see FIGS. 6A and 6B) become correlated. In view of this correlation, discovering statistical similarities of the disturbance functions in time is a viable way to identify a period of the coupling, i.e., a period during which a collaborative task is performed.

If the same robotic devices 102 are deployed with practically identical transfer functions, the temporal coupling can be identified by the transmission parameter controller 406 based on measurements taken for the coupled robotic devices 102.

Analytical Identification of Collaborative Tasks

Another way to identify the coupling period during a collaborative task is to calculate the transfer function of the coupled system in advance knowing the transfer functions of the decoupled control functions. If robotic devices 102 start to behave like the calculated transfer function of the coupled system, then this behavior indicates coupling and, thus, that a collaborative task is performed. The corresponding evaluation can be made by the transmission parameter controller 406 based on measurements.

It is feasible to do it the other way around: if a model is calculated of the independent robotic devices 102, and there is a deviation identified later from it, this means that either there is coupling or other kind of disturbance in the system. If, for example, the identified disturbance is larger than a certain threshold, then a switch to a high QoS channel 420 may happen.

Physical-Spatial Identification of Collaborative Tasks

The decision to switch between the two QoS channels 420, 422 and, thus, between the two associated QoC levels may also be dependent on the physical and spatial relationship between the robotic devices 102. This is due to the fact that a high QoC level is required when a robotic device 102 is close to interacting or is already interacting with another entity (e.g., another robotic device 102, a person, an object, etc.).

It is assumed that the pose (positioning and orientation) of the controllable elements (e.g., joints) of a robotic device 102 is measured at the same time as the pose of the other entity is measured. This can be performed using, for example, encoders, inertial measurement units (IMUs), visual sensors (for the robotic devices 102) or external visual sensors or positioning sensors for the other entity. A practical example is the following: if every part of a chair to be assembled by the robotic devices 102 has a specific fiducial, such as an AprilTag, for visual identification of an IMU sensor on it during the assembly process at least, the temporal collaboration of the robotic arms 102 can happen if the transmission parameter controller 406 detects, based on associated measurements, that moving either of the robot arms or both of them in parallel results in the same movement of the differences of, for example, the quaternion of the tool center point (TCP).

The technique presented herein may be implemented using a variety of robot programming tools and languages. For example, the robot programming language may be based on C++.

As has become apparent from the above exemplary embodiments, the technique presented herein permits a more efficient use of wireless transmission resources by, for example, intentionally relaxing transmission parameter settings for non-collaborative tasks that are, for example, less sensitive to delays. By properly selecting the periods of time for which the transmission parameter setting are relaxed, the overall performance of the robot cell 101 will not be negatively affected. As such, the same level of overall robot cell performance can be realized at a lower utilization of wireless resources.

Additionally, legacy communication protocols, in particular those previously used in wire-based control systems, can remain unchanged. As such, a cost effective and efficient solution for the transition from wire-based to wireless command transmission technologies in industrial environments can be realized. Moreover, a constantly high level of overall robot cell performance can be provided while efficiently utilizing wireless resources. Thus, the spectral efficiency of wireless communication can be increased.

While the present disclosure has been described with reference to exemplary embodiments, it will be appreciated that the present disclosure can be modified in various ways without departing from the scoop of the present disclosure as defined in the appended claims.

1-26. (canceled)

27. A controller for controlling wireless command transmission to at least a first robotic device, wherein the first robotic device is capable of selectively performing a collaborative task with another entity and a non-collaborative task, the controller comprising:
processing circuitry;
memory containing instructions executable by the processing circuitry whereby the controller is operative to:
identify if a task to be performed by the first robotic device is a collaborative or non-collaborative task; and
trigger a setting of at least one transmission parameter for a wireless command transmission to have the first robotic device perform the task, wherein the setting is dependent on whether the task to be performed is a collaborative or a non-collaborative task.

28. The controller of claim 27, wherein the transmission parameter setting for a collaborative task provides a higher Quality of Service (QoS) for wireless command transmission than the transmission parameter setting for a non-collaborative task.

29. The controller of claim 28, wherein the QoS is defined by: transmission latency, retransmission delay, packet loss, and/or jitter.

30. The controller of claim 27, wherein the transmission parameter setting for a collaborative task is associated with a lower control tolerance and/or a higher control update frequency than the transmission parameter setting for a non-collaborative task.

31. The controller of claim 27, wherein the collaborative task involves a physical interaction between the first robotic device and the other entity.

32. The controller of claim 27, wherein the other entity is a second robotic device.

33. The controller of claim 32, wherein the instructions are such that the controller is operative to trigger, when the task to be performed by the first robotic device is identified to be a collaborative task, wireless command transmission towards both the first robotic device and the second robotic device with a transmission parameter setting for the collaborative task.

34. The controller of claim 27, wherein the instructions are such that the controller is operative to evaluate measurements from a robot control function so as to identify if the task to be performed by the first robotic device is a collaborative or a non-collaborative task.

35. The controller of claim 34:
wherein:
the other entity is a second robotic device; or
the instructions are such that the controller is operative to trigger, when the task to be performed by the first robotic device is identified to be a collaborative task, wireless command transmission towards both the first robotic device and the second robotic device with a transmission parameter setting for the collaborative task; and
wherein the first robotic device is associated with a first robot control function and the second robotic device is associated with a second robot control function; and
wherein similarities in measurements taken in regard of the first and the second robot control functions are evaluated to identify that the task to be performed by the first robotic device is a collaborative task.

36. The controller of claim 35:
wherein the first robot control function comprises a first control loop and the second robot control function comprises a second control loop;
wherein the measurements are taken in regard to the first and the second control loops.

37. The controller of claim 34, wherein the instructions are such that the controller is operative to compare the measurements with a model for a collaborative robotic device system and/or a non-collaborative robotic device system to identify if the task to be performed by the first robotic device is a collaborative or a non-collaborative task.

38. The controller of claim 37, wherein the model is a model of a robotic transfer function and/or a time domain model.

39. The controller claim 34:
wherein:
the other entity is a second robotic device; or
the instructions are such that the controller is operative to trigger, when the task to be performed by the first robotic device is identified to be a collaborative task, wireless command transmission towards both the first robotic device and the second robotic device with a transmission parameter setting for the collaborative task; and
wherein the measurements pertain to differences of positions and/or orientations of the first and second robotic devices.

40. The controller of claim 27:
wherein the instructions are such that the controller is operative to inspect data packets so as to identify if the task to be performed by the first robotic device is a collaborative or a non-collaborative task;
wherein the data packets include commands to have at least the first robotic device perform the task and are intended for wireless command transmission to at least the first robotic device.

41. The controller of claim 27, wherein the instructions are such that the controller is operative to send a control signal to a radio network system in charge of wireless command transmission, wherein the control signal is configured to trigger the transmission parameter setting for the wireless command transmission.

42. The controller of claim 41, wherein the instructions are such that the controller is operative to send the control signal in-band with a command pertaining to the task to be performed by the first robotic device.

43. The controller of claim 41, wherein the instructions are such that the controller is operative to send the control signal out-of band and separately from a command pertaining to the task to be performed by the first robotic device.

44. A radio network system for wireless command transmission to one or more robotic devices, the radio network system comprising:
an interface to receive robotic device commands from a cloud-based robotic device control function for wireless transmission towards one or more robotic devices; and
a controller for controlling wireless command transmission to at least a first robotic device, wherein the first robotic device is capable of selectively performing a collaborative task with another entity and a non-collaborative task, the controller configured to:
identify if a task to be performed by the first robotic device is a collaborative or non-collaborative task; and
trigger a setting of at least one transmission parameter for a wireless command transmission to have the first robotic device perform the task, wherein the setting is dependent on whether the task to be performed is a collaborative or a non-collaborative task.

45. The radio network system of claim 44:
wherein the radio network system is configured to identify one or more wireless transceiver entities co-located and associated with the one or more robotic devices;
wherein the transmission parameter setting pertains to a wireless connection between the radio network system and each wireless transceiver entity.

46. The radio network system of claim 45, wherein the identification is based on a virtual extension local area network (VXLAN) tunnel to a robotic device, a robotic device identifier, and/or an Ethernet identifier of a robotic device.

47. A cloud-based robotic device control apparatus, comprising
a first interface configured to send robotic device commands to a radio network system for wireless transmission towards one or more robotic devices; and
a controller for controlling wireless command transmission to at least a first robotic device, wherein the first robotic device is capable of selectively performing a collaborative task with another entity and a non-collaborative task, the controller configured to:
identify if a task to be performed by the first robotic device is a collaborative or non-collaborative task; and
trigger a setting of at least one transmission parameter for a wireless command transmission to have the first robotic device perform the task, wherein the setting is dependent on whether the task to be performed is a collaborative or a non-collaborative task.

48. The cloud-based robotic device control apparatus of claim 47:
further comprising a second interface different from the first interface, the second interface configured to send control signals to the radio network system;
wherein the control signals are configured to trigger a transmission parameter setting for a wireless command transmission.

49. A method of controlling wireless command transmission to at least a first robotic device, wherein the first robotic device is capable of selectively performing a collaborative task with another entity and a non-collaborative task, the method comprising:
identifying if a task to be performed by the first robotic device is a collaborative or non-collaborative task; and
triggering a setting of at least one transmission parameter for a wireless command transmission to have the first robotic device perform the task, wherein the setting is dependent on whether the task to be performed is a collaborative or a non-collaborative task.
